(19) United States
(12) Patent Application Publication
(10) Pub. No.: US 2021/0237470 A1
(43) Pub. Date: Aug. 5, 2021

(54) SYSTEM AND METHOD FOR PRODUCING AN ULTRAVIOLET REFLECTIVE PHOTOREALISTIC IMAGE

(71) Applicant: Caliente LLC, Fort Wayne, IN (US)

(72) Inventors: Tyler W. Ambriole, Fort Wayne, IN (US); James T. Blake, Wolcottville, IN (US)

(73) Assignee: Caliente LLC, Fort Wayne, IN (US)

(21) Appl. No.: 17/150,182

(22) Filed: Jan. 15, 2021

Related U.S. Application Data
(60) Provisional application No. 62/962,254, filed on Jan. 17, 2020.

(51) Int. Cl. B41J 2/21

(52) U.S. Cl. CPC B41J 2/2132

(57) ABSTRACT

A method for producing a target including halftone printing an ink, by a printer, onto at least one ultraviolet reflective substrate. The method further includes applying at least one overlay material, by at least one overlay device, onto the at least one ultraviolet reflective substrate such that a photorealistic visible image and a photorealistic non-visible image are dually formed on the at least one ultraviolet reflective substrate.

### CROSS REFERENCE TO RELATED APPLICATIONS

This is a non-provisional application based upon U.S. provisional patent application Ser. No. 62/962,254, entitled “PRINTING PHOTOREALISTIC IMAGES ON ULTRAVIOLET REFLECTIVE MATERIAL”, filed Jan. 17, 2020, which is incorporated herein by reference.

### BACKGROUND OF THE INVENTION

### 1. Field of the Invention

The present invention relates to thermal targets, and more particularly, to a passive thermal target.

### 2. Description of the Related Art

Thermal targets can be in the form of active, electrically powered targets or passive targets which are not electrically powered. Much of the thermal target market utilizes electrical circuits that heat up via an electrical current flowing through the target to produce a thermal image. Because of the restrictions of this technology, options can be limited as to the thermal signature of the target as it is very difficult and costly to control temperatures in specific areas of the target via electrical current embodiments, normally leaving the entire target as a silhouette that has a single temperature gradient. Additionally, electrical targets require a power source in order to operate which can limit where and when it can be used.

Passive targets require no electricity. Passive targets utilize a special material set that absorbs or reflects ultraviolet (UV) light, which when observed through an infrared camera or scope, showing a thermal image on the infrared spectrum.

Typically, solid black images are printed on a specially coated UV reflective material. Solid black images may be printed on the material utilizing a specialized type of large format Cyan Magenta Yellow Black (CMYK) ink printer. Anywhere that solid black was printed, would inhibit the absorption of UV light, showing as hot on the infrared spectrum when observed with an infrared camera. black material absorbs UV light while the UV reflective material reflects the UV light. The contrast between the printed area and the UV reflective material provides a thermal signature. Hence, anywhere on the material where the black was not printed would reflect UV light and show as a cold spot. Because there is no need for electricity, a large benefit to passive thermal targets is that they are portable, have no wires, and can be used to easily mark either targets or friendly subjects. Thus, UV reflective targets are able to be used in more training environments and scenarios where traditional electrically energized thermal targets may not be easily accommodated.

What is needed in the art is a durable target which more accurately represents a visual representation and thermal signature of a given subject.

### SUMMARY OF THE INVENTION

The present invention provides a photorealistic thermal target and a method of manufacture thereof. The method includes halftone printing an ink, by a printer, onto at least one ultraviolet reflective substrate. The method further includes applying at least one overlay material, by at least one overlay device, onto the at least one ultraviolet reflective substrate such that a photorealistic visible image and a photorealistic non-visible image are dually formed on the at least one ultraviolet reflective substrate.

The invention in one form is directed to a method for producing a target. The method includes halftone printing an ink, by a printer, onto at least one ultraviolet reflective substrate. The method further includes applying at least one overlay material, by at least one overlay device, onto the at least one ultraviolet reflective substrate such that a photorealistic visible image and a photorealistic non-visible image are dually formed on the at least one ultraviolet reflective substrate.

The invention in another form is directed to a printing system for printing a target. The printing system includes a printer having a printing head configured to halftone print an ink onto at least one ultraviolet reflective substrate. The printing system also includes at least one overlay device configured to apply at least one overlay material onto the at least one ultraviolet reflective substrate such that a photorealistic visible image and a photorealistic non-visible image are dually formed on the at least one ultraviolet reflective substrate.

The invention in yet another form is directed to a target. The target includes at least one ultraviolet reflective substrate, a halftoned image printed onto the at least one ultraviolet reflective substrate, and at least one overlay material on the at least one ultraviolet reflective substrate. The halftoned image and the at least one overlay material are configured to collectively form a photorealistic visible image and a photorealistic non-visible image on the at least one ultraviolet reflective substrate.

An advantage of the present invention is that the passive thermal target dually represents a photorealistic visible image and a photorealistic non-visible image.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a schematic view of a printing system in accordance with an exemplary embodiment of the invention;

FIG. 2 illustrates an embodiment of a full-scale photorealistic target as viewed with the naked eye;

FIG. 3 illustrates the photorealistic target of FIG. 2 as viewed with a thermal imaging device;

FIG. 4 illustrates a portion of the photorealistic target at a distant vantage point, wherein the halftoned printed image appears to be a substantially solid image;

FIG. 5 illustrates the photorealistic target at a closer vantage point, wherein the pattern formation is readily apparent;

FIG. 6 illustrates the photorealistic target at an even closer vantage point, wherein the shapes and gaps between the shapes of the halftoned printed image are readily apparent;

FIG. 7 illustrates another embodiment of a photorealistic target as viewed with the naked eye;

FIG. 8 illustrates the photorealistic target of FIG. 7 as viewed with a thermal imaging device; and

FIG. 9 illustrates another embodiment of a photorealistic target being depicted at multiple angles relative to the ground.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

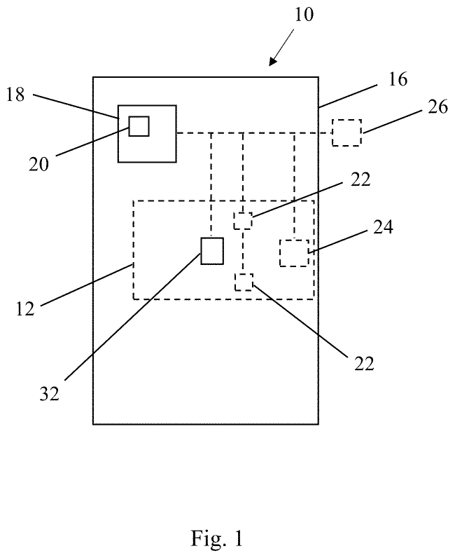

Referring now to the drawings, and more particularly to FIGS. 1-3, there is shown, a schematic view of a printing system 10 for printing a photorealistic image onto a substrate 12 to form a photorealistic target 14. The printing system 10 may generally include an ink printer 16, a controller 18 with a memory 20, one or more nonvisible lights 22, and one or more overlay devices 24, 26 for applying at least one overlay material 28 onto one or more sections of the substrate 12.

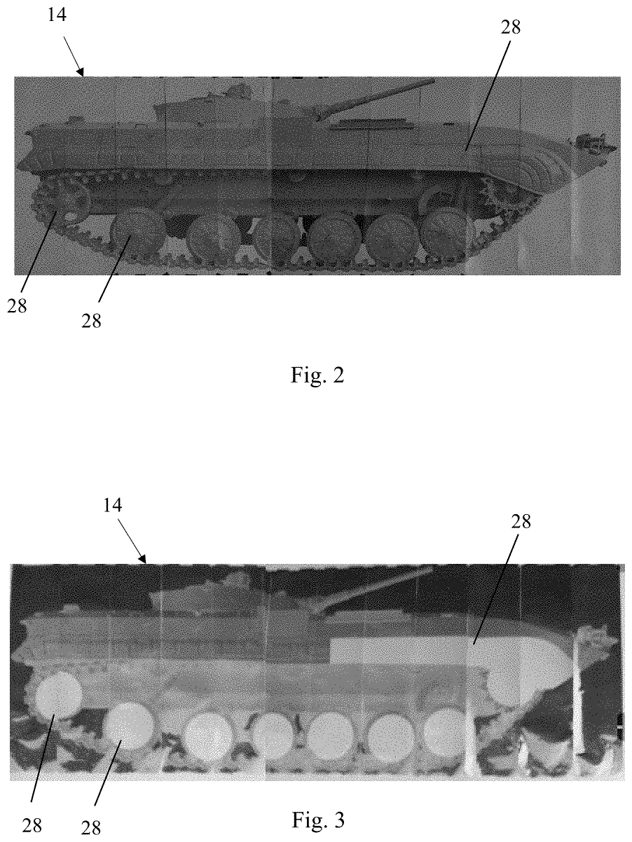

The photorealistic target 14 is a multidimensional target in that the image thereof is both a photorealistic visible image, which is visible with the naked eye as shown in FIG. 2, and a photorealistic non-visible image, e.g. a thermal image, which is visible with a thermal imaging device as shown in FIG. 3. The photorealistic target 14 is a passive and durable thermal target. Therein, the photorealistic target 14 is not coupled to or provided with electrical power. The photorealistic target 14 can be used in any desired application. For example, the photorealistic target 14 can be used as a target, or object of interest, for a military or police force training exercise. Therein, the photorealistic target 14 can be used in live-fire training exercises to mark or otherwise indicate friendly and/or nonfriendly targets. The photorealistic target 14 can also be used as a decoy which attempts to draw attention thereto. Additionally, the photorealistic target 14 can be in the form of a sign, such as a traffic sign, road sign, or advertisement. Furthermore, the photorealistic target 14 can be in the form of any desired object that can be observed with both the naked eye and a thermal imaging device, such as a thermal scope, an infrared camera, sensor, etc. In addition, the photorealistic target 14 could be used without the aid of infrared sensors in order to have a convincing realistic non-thermalized visual target.

The photorealistic target 14 can be comprised of a single section that is formed on one or more substrates 12. The photorealistic target 14 can also be comprised of multiple sections that are formed on one or more substrates 12. If multiple substrates 12 are used to form the photorealistic target 14, the substrates 12 may or may not be composed of the same material. The photorealistic target 14 incorporates halftone printing methodologies which allow for more than a binary hot-cold image on the infrared spectrum. The photorealistic target 14 can be produced to cost effectively allow for gradients in temperature which can help improve how realistic the target seems.

The substrate 12 may be in the form of an ultraviolet (UV) reflective substrate. For example, the substrate 12 may be in the form of a sheet with a UV reflective material coated thereto. The substrate 12 may comprise any desired material. For example, the substrate may include a paper material, a coated nylon material, and/or an aluminum sheeting. For example, the substrate 12 may include a passive material such as CT-P242C which is manufactured by Caliente, LLC.

The printer 16 typically includes a frame and a printing head 30 for dispensing ink onto the substrate 12. The printer 16 may additionally include the controller 18. The printer 16 may further include the one or more nonvisible lights 22 and the overlay device 24. However, the nonvisible light(s) 22 and/or the overlay device 24 may be incorporated as part of a separate device. Thereby, the nonvisible light(s) 22 and the overlay devices 24, 26 have been illustrated in phantom in FIG. 1. The printer 16 can be in the form of a Cyan Magenta Yellow Black (CMYK) ink printer. However, the printer 16 may be in the form of any desired printer. The printer 16 may or may not utilize a curable ink such as an actinic curable ink. The curable ink may reflect UV light when cured and in application.

The controller 18 can be operably coupled to the printing head 30, the one or more nonvisible lights 22, and the overlay device(s) 24, 26. In one embodiment, the controller 18 may not be coupled to nonvisible lights and/or the overlay device(s) 24, 26. The controller 18 may be configured to set and/or adjust the halftone printing process, e.g. a pattern density, a pattern size, a pattern shape, and/or a pattern geometry of a halftone of the ink, depending upon a preset value, e.g. a predetermined optimal pattern shape corresponding to a certain type of substrate 12, the at least one overlay material, an angle of the target in application, and/or a height of the target in application. The controller 18 may be in the form of any desired controller.

Each nonvisible light 22 may be configured to cure the curable ink. Each nonvisible light 22 may be incorporated as part of the printer 16. Each nonvisible light 22 may furthermore be connected to and move with the printing head 30. Alternatively, each nonvisible light 22 may be a separate element which is not directly connected to the printer 16. Each nonvisible light 22 may be in the form of any desired nonvisible light. For instance, each nonvisible light may comprise a UV light. It is conceivable that the printing system 10 may not include the one or more nonvisible lights 22.

The one or more overlay devices 24, 26 may be configured to apply at least one overlay material 28 onto the substrate 12. The one or more overlay devices 24, 26 may apply the overlay material(s) 28 to designated sections of the image in order to alter the emissivity and/or absorption of visible and/or nonvisible light. For instance, the one or more overlay devices 24, 26 may apply multiple overlay materials 28 onto the image to increase or decrease the thermal signature of a section of the image, such as the engine, wheels and/or tracks, windows, etc., of a vehicle. Thereby, the overlay material(s) 28 may enhance the thermal signature of the photorealistic image. Additionally, for instance, the overlay material 28 can be used to create hot spots while in no way degrading the photo realistic properties of the target 14. It should be appreciated that the overlay material(s) 28 may not be necessary to achieve a desired thermal signature of the photorealistic target 14.

The printing system 10 may include only one overlay device 24 which may be incorporated as part of the printer 16. If the overlay device 24 is incorporated as part of the printer 16, the overlay device 24 can be connected to or movably mounted adjacent to the printing head 30. Alternatively, the printing system 10 may include only one overlay device 26 which is not incorporated as part of the printer 16 such that the overlay device 26 is a separate element. The separate overlay device 26 may or may not be coupled to the controller 18. Furthermore, the printing system 10 may include two or more overlay devices 24, 26 for applying respective overlay materials 28 onto the substrate 12.

Each overlay device 24, 26 can be in the form of an automatic and/or a manually operated device for applying the one or more overlay materials 28 onto the printed image which has been previously printed onto the substrate 12. By way of example only, the overlay device(s) 24, 26 may be in the form of a roller, a spray head or nozzle, and/or a tape dispenser. The overlay material(s) 28 which may be applied on top of or underneath the substrate 12 may be in the form of a plastic overlay, a clear tape, a green dielectric tape, various colors of electrical tape, and a clear polyethylene terephalate (PET) overlay. It is conceivable that the overlay material may be in the form of a green backing to a powered thermal target. It is also conceivable that a user may manually apply the overlay device onto the substrate.

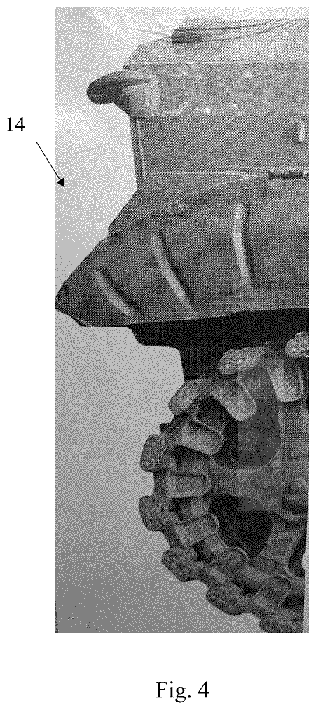

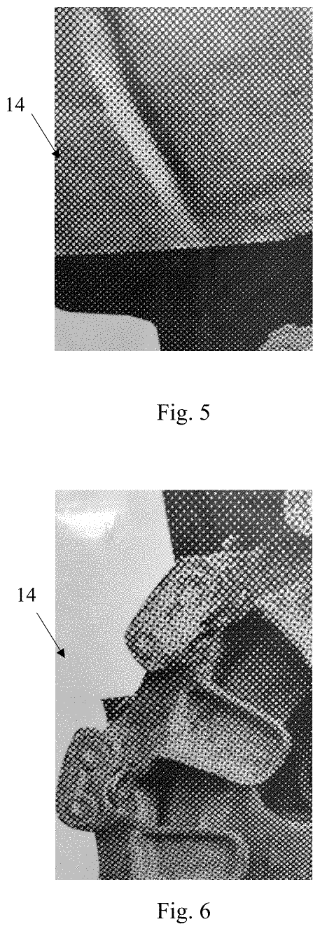

Referring now collectively to FIGS. 1-6, the printer 16 may utilize halftone printing in applying the ink onto the substrate 12. Halftone printing is defined as a type of printing where a complete solid image is not printed in full but rather is printed as a series of sections which therein form predetermined gaps or spaces to ultimately form an image. The halftone images can be created by varying the geometry of the shapes, size of shape, and sizes of gaps between the shapes in order to enhance or degrade the UV reflective properties of the image. The printer 16 may halftone print the image in any desired configuration. For instance, the printer 16 may print halftones with a normal fill, halftones with round shapes, halftones with diamond shapes, halftones with Euclid Dot shapes, and halftones with a planar or line shape. FIG. 4 illustrates the photorealistic target 14 at a distant vantage point, wherein the halftoned appears to be a substantially solid image. FIG. 5 illustrates the photorealistic target 14 at a closer vantage point, wherein the pattern formation is readily apparent. FIG. 6 illustrates the photorealistic target 14 at an even closer vantage point, wherein the shapes and gaps between the shapes are readily apparent.

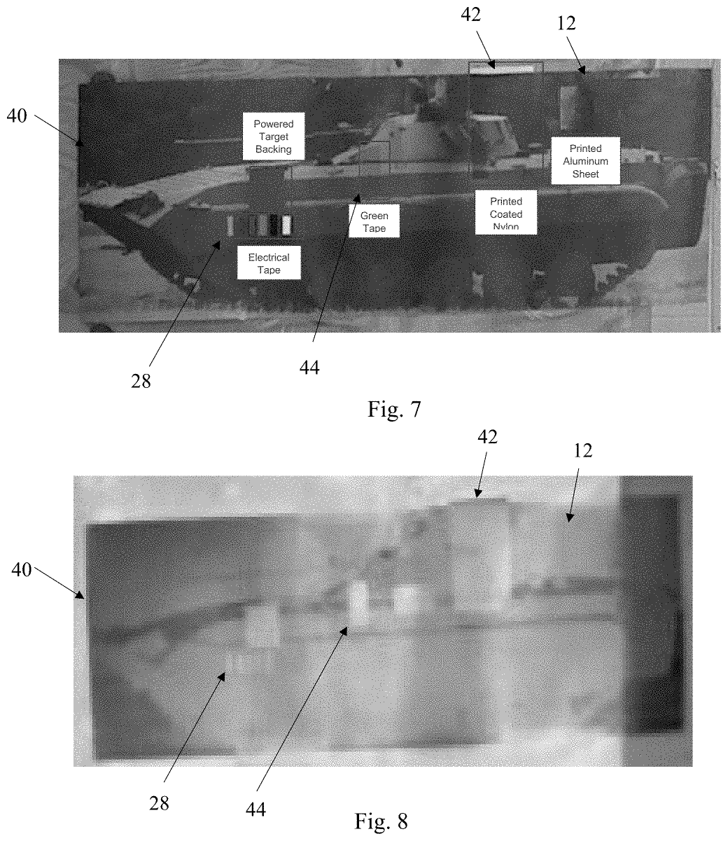

Referring now specifically to FIGS. 7-8, there is shown another exemplary embodiment of a photorealistic target 40. The photorealistic target 40 may include at least one substrate 12, 42 and at least one overlay material 28. For instance, the photorealistic target 40 may include a first substrate 12 in the form an aluminum sheet and a second substrate 42 in the form of a coated nylon material. The photorealistic target 40 may include two or more overlays 28, 44 in the form of variously colored electrical tape 28 and green tape 44. FIG. 7 illustrates the photorealistic target 40 as viewed with the naked eye. FIG. 8 illustrates the photorealistic target 40 as viewed with a thermal imaging device.

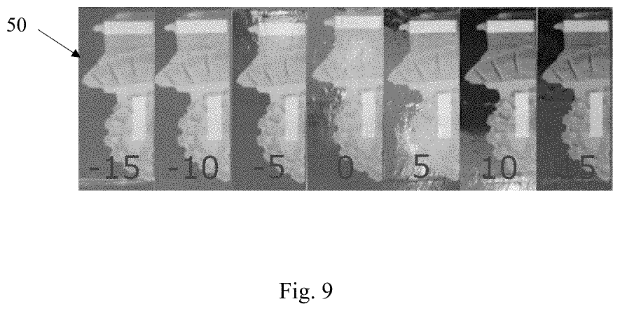

Referring now to FIG. 9, there is shown a thermal target 50 depicted at various angles relative to a horizontal plane, e.g. the ground. As shown, a large-scale print on a single panel was produced and tested by altering the angle of the target between −15°, −10°, −5°, 0°, 5°, 10°, and 15° as referenced to the ground. At all angles, a distinct infrared image was able to be obtained. In this case, a positive angle is defined by the surface of the image facing the sky. A negative angle is defined by the surface of the image facing the ground. Therein, the computer 18 may determine a desired angle of the target 50 relative to the ground for a given substrate(s), halftone, and/or overlay material(s).

In operation, the printing system 10 may initially apply a UV reflective material onto the substrate 12. Alternatively, the substrate 12 may already have a UV reflective material coating thereon. Then, the printing system 10 may halftone print a photorealistic image onto a substrate 12 by the printer 16. The printer 16 may print the entire image with one particular halftone pattern, e.g. a circular pattern. Additionally, the printer 16 may print multiple, differing halftone patterns within a given image. The step of halftone printing the image may further include setting and adjusting, by the controller 18, the halftone of the entire image or sections of the image. For example, the controller 18 may control the printer 16 to set the halftone depending upon a desired preset emissivity and/or absorption of a given section of the image, an overlay material, desired angle of the target in application, and/or desired height of the target in application. The computer 18 may modify the halftone by adjusting the image density by changing the pattern density, pattern size, pattern shape, the placement thereof relative to the substrate and/or overlay material, and/or pattern geometry. Additionally for instance, the computer 18 may automatically adjust the emissivity and/or an absorption of the photorealistic non-visible image by adjusting a pattern density, a pattern size, a pattern shape, and/or a pattern geometry depending upon a desired preset value, e.g. desired absorption rate to achieve a preset thermal signature, the at least one overlay material, an angle of the target in application relative to a desired horizontal plane, e.g. the ground, and/or a height of the target in application relative to a desired horizontal plane. Concurrently with halftone printing the image, or subsequently thereafter, the printing system 10 may cure the curable ink. For instance, the one or more nonvisible lights 22 may cure the actinic curable ink right after it has been deposited onto the substrate 12. Thereafter, the printing system 10 may apply an overlay material onto the substrate 12 by way of an automatic and/or manually operated overlay device(s) 24, 26. For instance, the computer 18 may direct each overlay device 24, 26 to respectively apply one or more overlay materials onto the cured ink. Thereby, the computer 18 may automatically adjust the emissivity and/or absorption of visible and/or nonvisible light by altering the halftoning and/or overlay material in one or more desired sections of the photorealistic target 14.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a target, comprising:
halftone printing an ink, by a printer, onto at least one ultraviolet reflective substrate; and
applying at least one overlay material, by at least one overlay device, onto the at least one ultraviolet reflective substrate such that a photorealistic visible image and a photorealistic non-visible image are dually formed on the at least one ultraviolet reflective substrate.

2. The method of claim 1, further comprising setting, by a controller, a pattern density, a pattern size, a pattern shape, and/or a pattern geometry of a halftone of the ink depending upon a preset value, the at least one overlay material, an angle of the target in application, and/or a height of the target in application.

3. The method of claim 1, wherein halftone printing the ink comprises printing a curable ink.

4. The method of claim 3, wherein the curable ink is an actinic curable ink.

5. The method of claim 3, further comprising a step of curing the curable ink by at least one nonvisible light.

6. The method of claim 1, wherein applying at least one overlay material comprises applying two or more overlay materials in two or more differing sections of the at least one ultraviolet reflective substrate.

7. The method of claim 1, wherein the at least one overlay material is applied to at least one section of the at least one ultraviolet reflective substrate to increase or decrease a thermal signature of the at least one section.

8. The method of claim 1, wherein the at least one ultraviolet reflective substrate comprises two or more ultraviolet reflective substrates.

9. A printing system for printing a target, comprising:
a printer having a printing head configured to halftone print an ink onto at least one ultraviolet reflective substrate; and
at least one overlay device configured to apply at least one overlay material onto the at least one ultraviolet reflective substrate such that a photorealistic visible image and a photorealistic non-visible image are dually formed on the at least one ultraviolet reflective substrate.

10. The printing system of claim 9, further comprising a controller configured to set a pattern density, a pattern size, a pattern shape, and/or a pattern geometry of a halftone of the ink.

11. The printing system of claim 10, wherein the controller is configured to set the pattern density, the pattern size, the pattern shape, and/or the pattern geometry of the halftone of the ink depending upon a preset value, the at least one overlay material, an angle of the target in application, and/or a height of the target in application.

12. The printing system of claim 9, wherein the ink comprises a curable ink.

13. The printing system of claim 12, wherein the curable ink is an actinic curable ink.

14. The printing system of claim 12, further comprising at least one nonvisible light configured to cure the curable ink.

15. The printing system of claim 9, wherein the at least one overlay material comprises two or more overlay materials in two or more differing sections of the at least one ultraviolet reflective substrate.

16. The printing system of claim 9, wherein the at least one overlay device is configured to apply the at least one overlay material onto at least one section of the at least one ultraviolet reflective substrate to increase or decrease a thermal signature of the at least one section.

17. The printing system of claim 9, wherein the at least one ultraviolet reflective substrate comprises two or more ultraviolet reflective substrates.

18. A target, comprising:
at least one ultraviolet reflective substrate;
a halftoned image printed onto the at least one ultraviolet reflective substrate; and
at least one overlay material on the at least one ultraviolet reflective substrate,
wherein the halftoned image and the at least one overlay material are configured to collectively form a photorealistic visible image and a photorealistic non-visible image on the at least one ultraviolet reflective substrate.

19. The target of claim 18, wherein the ink comprises a curable ink.

20. The target of claim 18, wherein the at least one overlay material comprises two or more overlay materials in two or more differing sections of the at least one ultraviolet reflective substrate.
